(19) United States
(12) Patent Application Publication
(10) Pub. No.: US 2007/0083674 A1
(43) Pub. Date: Apr. 12, 2007

(54) Method and apparatus for republishing electronic content from a wireless communication device

(75) Inventors: Jonathan M. Mulder, Cary, NC (US); Ivan Nelson Wakefield, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB

(21) Appl. No.: 11/246,423

(22) Filed: Oct. 7, 2005

(51) Int. Cl. G06F 15/16

(52) U.S. Cl. 709/246

(57) ABSTRACT

A wireless communication device, such as a cellular handset, is configured to retrieve published content through a supporting communication network, modify the published content by adding content and republish the modified content through the supporting communication network. For example, the device may retrieve published content through a web feed, offer its user the ability to add commentary or other modifications to the content, and republish the modified content. In at least one embodiment, republishing of the modified content comprises posting the modified content for access through a web feed, which may be the same or different from the originating feed, so that the modified content is identifiable as a republished version of originally posted content. As one example, the device's user could retrieve audio content, such as from a podcast, listen to the content, insert comments as desired, and republish the modified content, all while operating in a mobile environment.

### BACKGROUND

The present invention relates to wireless communication devices, such as cellular handsets, and particularly relates to republishing electronic content, such as that obtained from a web feed, from such devices.

Web feeds represent an increasingly popular means for providing electronic content. As one example, establishing a web feed is accomplished by placing an eXtensible Markup Language (XML) document on a network-accessible computer, e.g., a web server. More particularly, the XML document includes an item list with embedded electronic content, or with links to such content. Feed subscribers watch or otherwise monitor the file for item list changes, so that new content can be accessed when it becomes available.

Various mechanisms exist for subscribing to web feeds. As one example, a personal computer (PC) may be configured with aggregator software. Aggregators monitor selected web feeds and provide their users with updated content listings, and can be configured to automatically retrieve updated content from selected feeds. Aggregators that target specific types of feeds generally have specialized names. For example, aggregators targeting news feeds (e.g., RSS-based news feeds) are often referred to as news readers, while aggregators targeting “podcast” feeds are often referred to as “podcatchers.”

Podcast feeds typically comprise item lists that include or link to audio files, e.g., MP3 files, but the term does not exclude other content type, such as video. Podcasting perhaps finds its greatest use by both professionals and amateurs in publishing serial audio content to the web. For example, well known radio (or online) talk and special interest programs oftentimes are made available as downloadable audio or video files through web feeds that are updated as new content is posted. So called “bloggers” also frequently post new content, which may be downloaded by interested users through the corresponding web feeds.

While perhaps not a uniformly defining hallmark, most web feeds offer frequently updated content and thus provide topical information that may be of great interest to subscribers on a daily, hourly, or even minute-by-minute basis. The currency of content accessed through such feeds thus complements the use of mobile wireless communication devices. That is, the desire to access web feed content regardless of time and location makes the ability to subscribe to web feeds and retrieve their associated content via wireless communication devices an attractive and increasingly popular option.

### SUMMARY

A wireless communication device, such as a cellular handset, is configured to retrieve published content through a web feed, offer its user the ability to add commentary or other modifications to the content, and republish the modified content. In at least one embodiment, the republishing of the modified content comprises posting the modified content for access through a web feed, which may be the same or different from the originating feed, so that the modified content is identifiable as a republished version of originally posted content. As one example, the device's user could retrieve audio content, such as from a podcast, listen to the content, insert comments as desired, and republish the modified content, all while operating in a mobile environment.

Of course, the present invention is not limited to the above features and advantages. Indeed, those skilled in the art will recognize additional features and advantages upon reading the following detailed discussion, and upon viewing the accompanying drawings.

### BRIEF DESCRIPTION OF THE DRAWINGS

FIG. 1 is a block diagram of a wireless communication device and a supporting wireless communication network configured for republishing electronic content.

FIG. 2 is a block diagram of a republishing function, which may be implemented as a computer program within the wireless communication device of FIG. 1.

FIG. 3 is a logic flow diagram according to one embodiment of content republishing.

FIG. 4 is a block diagram of a republishing modification function, illustrating one or more types of republication information that can be added to electronic content as part of a republication method.

### DETAILED DESCRIPTION

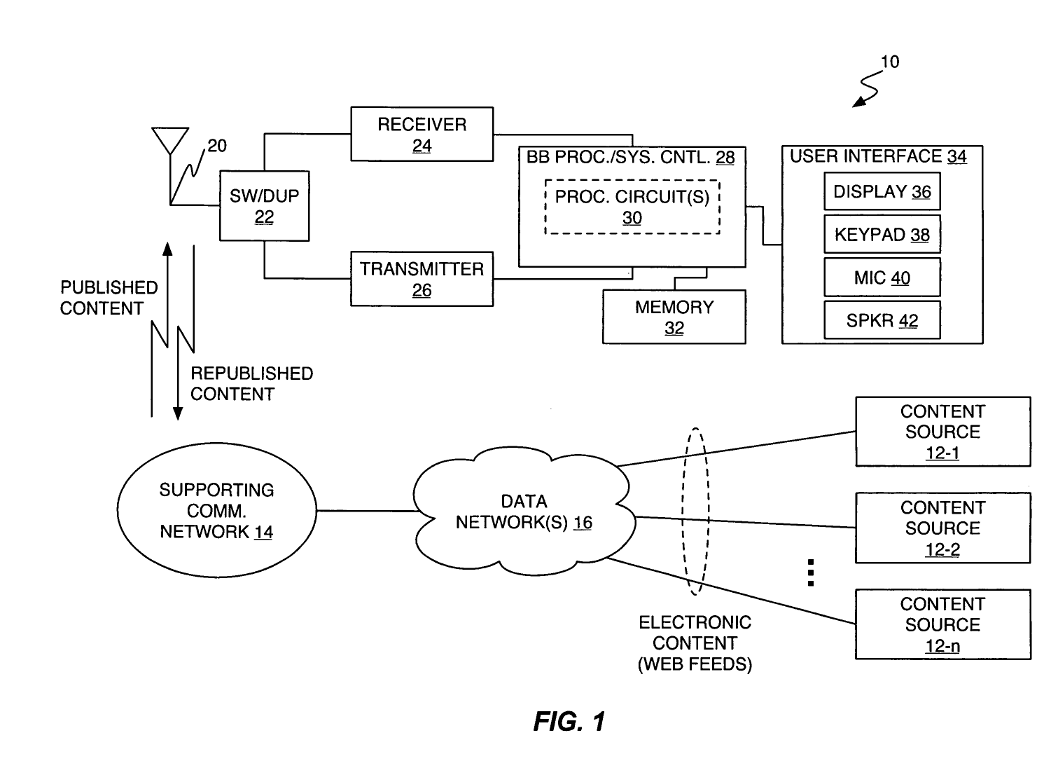

FIG. 1 illustrates a wireless communication device 10 that is communicatively coupled to one or more (electronic) content sources 12 directly or indirectly through a supporting wireless communication network 14. The content source(s) 12 provide published content through podcasts or other types of web feeds, and the device 10 is configured to support retrieval, modification, and republication of such content. The potentially rich user interface and wireless mobility of the device 10 complements these actions, and permits a user of the device 10 to download feed content, view or listen to the content, add or modify the content—such as by adding commentary to a downloaded podcast file—and then republish the modified content.

In the illustration, for example, the supporting wireless communication network 14 links or otherwise communicatively couples with one or more data networks 16, such as the Internet, that provide the device 10 with access to the content source(s) 12. In the depicted embodiment, the device 10 comprises a receive/transmit antenna 20, a switch/duplexer 22, a receiver circuit 24, a transmitter circuit 26, baseband processing/system control circuits 28, which include one or more processing circuits 30 configured to support published content retrieval, modification, and republication, memory circuit(s) 32, and a user interface 34. In at least one embodiment, the user interface 34 includes a display 36, a keypad 38, a microphone 40, and a speaker 42 (or other audio output device or system).

By way of non-limiting example, the device 10 comprises a cellular handset, such as a GSM/GPRS or Wideband CDMA (WCDMA) handset and, in turn, the supporting communication network 14 comprises a cellular network, including radio access and core network entities as needed to support wireless communication with the device 10, and backend communication with the data network(s) 16.

Of course, it should be understood that the device 10 can be configured as a wireless pager, PDA, palmtop/laptop computer, or other type of portable communication device. The intended use and the desired features will dictate the particular implementation of the device 10, and it should be understood that the particulars of supporting communication network 14 will change according to the particular implementation of the device 10. For example, the supporting communication network 14 may comprise a short-range radio network, such as WiFi or Bluetooth, or may comprise a wider area radio network, such as WiMax, and that the communication circuits (receiver 24 and transmitter 26) of the device 10 will be configured as needed to support the particular air interface(s) desired in a given implementation.

Regardless, the one or more processing circuits 30 of the device 10 are configured to retrieve published content through the supporting communication network 14, modify the published content by adding content, and republish the modified content through the supporting communication network 14. As such, the processing circuit(s) 30 may comprise one or more microprocessors, digital signal processors, application specific integrated circuits, field programmable gate arrays, and/or other types of digital processing circuits, configured according to computer program instructions implemented in software (or firmware). Such circuits may be shared with other signal and control functions of the baseband processor/system control circuits 28.

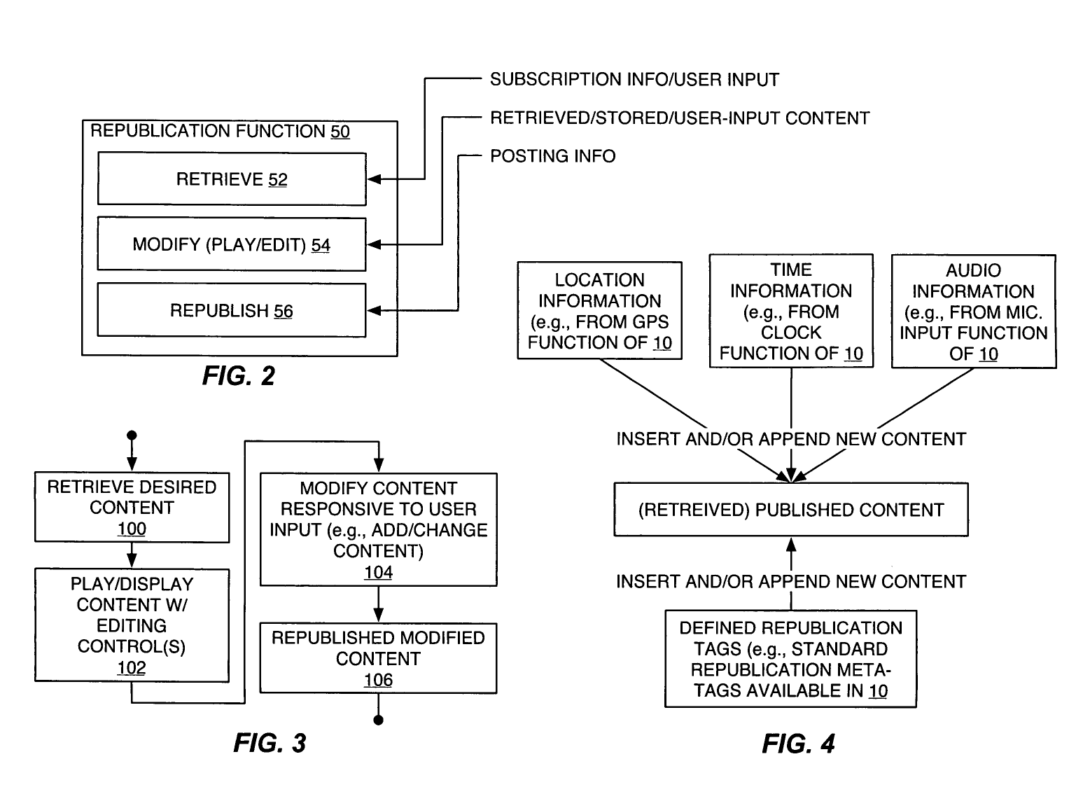

FIG. 2 illustrates a content republishing function 50 that may be implemented by executing computer program instructions, such as might be stored in the memory circuit(s) 32, via the one or more processing circuits 30. FIG. 3 illustrates corresponding program logic that may be implemented by the functional elements of the republishing function 50.

Referring to FIG. 3, one sees that processing “begins” with the retrieval of (desired) published content from the one or more content sources 12 (Step 100). Thus, the content retrieval function 52 shown in FIG. 2 may be configured to retrieve published content from the content source(s) 12 based on, for example, configured subscription information or user input.

For example, the republishing function 50 may display available web feed information on the display 36, and receive selection input from a user of the device 10 via the keypad 38, indicating which feeds should be monitored for the availability of newly published content. The retrieval function 52 thus may maintain feed subscriptions to podcasts and the like, and retrieve (download) newly published content to the device 10 when it becomes available, or when the device's user provides input indicating that such retrieval is desired.

The processing flow of FIG. 3 continues with the modification of retrieved published content (Step 102), which may be accomplished by playing/displaying the retrieved content for editing by the device's user. Thus, the modification function 54 shown in FIG. 2 may be configured as a playback/edit function that permits the device's user to see (or hear) and edit published content retrieved to the device 10. Processing continues with the modification of the retrieved published content (Step 104) via the modification function 54. That is, the modification function 54 allows the user to add content of the same or different type to the retrieved content.

For example, the modification function 54 may be configured to playback downloaded audio files, using onscreen playback and edit controls, thereby allowing the user to listen to a given file, and insert or append new audio commentary to the file as desired. Thus, the user could pause playback at a given time point in the file and insert personal commentary (e.g., points of agreement, disagreement, etc.) by speaking into the microphone 40 of the user interface 34.

Processing in FIG. 3 continues with republication of the modified content (Step 106). To that end, a republish function 56 as shown in FIG. 2 provides for automatic and/or user-directed republication of the modified content. In one example, the modified content is republished to the same feed from which corresponding published content was retrieved, or at least linked to the same feed, so that the original and modified content are both available to subscribers of the feed. In other embodiments, the republished content may be posted to the same feed, to a different feed, or to multiple feeds.

With the above details in mind, it will be generally understood that the one or more processing circuits 30 may be configured, i.e., through implementation of the republishing function 50 as software or firmware, to retrieve published content through the supporting communication network 14, modify the published content by adding content, and republish the modified content through the supporting communication network 14 to make the republished modified content available for retrieval by others, for example. Such operations may comprise downloading audio content from a web feed accessible through the supporting communication network 14 and modifying the retrieved audio content by adding new audio content.

The (audio) web feeds may comprise podcasts, such that the downloaded audio content comprises an audio file associated with a given podcast, and such that modification of the downloaded audio content comprises providing editing functions via the user interface 34 to allow inserting or appending new audio content received via the user interface 34. However, regardless of the downloaded or added content type, it should be understood that the one or more processing circuits 30 may be configured to republish the modified content by updating a web feed to list the modified electronic content as a republished version of the published electronic content.

To that end, the one or more processing circuits 30 may be configured to modify the published content by adding particular types of content that may be advantageously available in the device 10. For example, FIG. 4 indicates that, in addition to, or as an alternative to, any new content generated or selected by the user for addition to the retrieved content, the one or more processing circuits 30 may be configured to add republication information as part of the modification and republication of retrieved content.

For example, the one or more processing circuits 30 may be configured to add republication information by at least one of inserting or appending time information to indicate a modification time, inserting or appending wireless communication device location information to indicate a modification location, and inserting or appending defined republication tags to aid in later identification and retrieval of the republished content.

The location information may be readily available within the device 10, which may acquire or otherwise receive location information in support of other functions independent from the republication function 50. As a non-limiting example, the baseband/system control circuits 28 may include or be associated with a GPS location circuit, which may have corresponding signal reception circuits included in or associated with the receiver circuit 24. GPS reception may share the receive/transmit antenna 20 depicted in FIG. 1, or may use another antenna (not pictured). Of course, the particular mechanism used for determining the location of the device 10 is not limiting with respect to its use as republication information to “location-stamp” republished content. Location stamping provides relevant information, for example, as evidence that republished content is relevant to a particular location.

As another example of republication information already available within the device 10, the device's clock time (time-of-day) may be used to time stamp the modifications made to the retrieved content. Such information provides time-of-day modification information, which may be useful to other users interested in identifying and retrieving republished content.

As another example, the one or more processing circuits 30 may be configured to add republication tags to the modified content to aid in later identification and retrieval of the republished content. Such tags may be meta-tags, such as used in web feeds using XML-based listing or content files available on or through the content servers 12. The meta-tags may be part of, or may define, a republication grammar that identifies the nature of a given republication-critique, commentary, expansion, etc. and may provide identifiers regarding the type of content added-e.g., text, photo, video, multimedia. The memory circuit(s) 32 may store republication tags and/or the device 10 may retrieve custom or standardized republication tags from the content servers 12, for example.

As a further convenience feature, the one or more processing circuits 30 may be configured to generate a user interface indication of new content availability in one or more electronic feeds accessible by the device 10 through the supporting communication network 14. Thus, the user interface 34 may be used to display an indicator—e.g., an icon—on the display screen 36 and/or to output an audible signal via the speaker 42. The new content indication function may be configured to identify when new (original) content is published on one or more selected web feeds and/or to identify when republished content is posted to, or otherwise made available, thereby allowing, for example, pluralities of users to stay informed of the others' republication activities.

In support, the content servers 12 may provide the supporting communication network 14 with indications of new content availability, and the supporting communication network 14 can be configured to generate and transmit over-the-air signaling to targeted users-e.g., users subscribed to an updated web feed. Such functionality can be incorporated into existing packet data entities, such as Multimedia Gateways (MGWs) or Packet Data Serving Nodes (PDSNs), or a new entity may be added to a packet core network included in the supporting communication network 14, or to an associated Internet Multimedia Subsystem (IMS).

Regardless of such additional features and capabilities, those skilled in the art should appreciate that the present invention broadly provides a wireless communication device that is configured for retrieval, playback or display, editing, and republication of electronic content available through one or more electronic feeds, all while operating in the mobile environment. Thus, the present invention is not limited to the features and advantages detailed in the foregoing description, nor is it limited by the accompanying drawings. Indeed, the present invention is limited only by the following claims, and their legal equivalents.

What is claimed is:

1. In a wireless communication device, a method of republishing previously published content of an electronic format, the method comprising:
retrieving published content through a supporting communication network;
modifying the published content by adding content; and
republishing the modified content through the supporting communication network.

2. The method of claim 1, wherein retrieving published content through a supporting communication network comprises downloading audio content from a web feed accessible through the supporting communication network, and wherein modifying the published content by adding content comprises adding audio content to the downloaded audio content.

3. The method of claim 2, wherein republishing the modified content through the wireless communication network comprises updating a web feed to list the modified content as a republished version of the published content.

4. The method of claim 2, wherein the web feed comprises a podcast, and wherein downloading the audio content comprises downloading an audio file associated with the podcast, and wherein modifying the published content by adding content comprises providing editing functions via a user interface of the wireless communication device, and inserting or appending new audio content received from a user of the wireless communication device via the user interface.

5. The method of claim 1, wherein retrieving published content through a supporting communication network comprises retrieving content published in a web feed that is accessible via the supporting communication network.

6. The method of claim 1, wherein modifying the published content by adding content comprises adding republication information as at least part of said content.

7. The method of claim 1, wherein adding republication information comprises adding defined republication tags to aid in later identification and retrieval of the republished content.

8. The method of claim 6, wherein adding republication information comprises at least one of inserting or appending time information to indicate a modification time, inserting or appending wireless communication device location information to indicate a modification location, and inserting or appending defined republication tags to aid in later identification and retrieval of the republished content.

9. The method of claim 10, wherein inserting or appending wireless communication device location to indicate a modification location comprises inserting or appending location information to the published content that identifies where the wireless communication device was located during modification of the published content.

10. The method of claim 1, further comprising generating an indication via a user interface of the wireless communication device of content availability in one or more electronic feeds accessible by the wireless communication device through the supporting communication network.

11. The method of claim 10, wherein generating an indication via a user interface of the wireless communication device of content availability in one or more electronic feeds accessible by the wireless communication device through the supporting communication network comprises displaying an icon or other indicator on a display screen of the wireless communication device.

12. The method of claim 1, wherein modifying the published content by adding content comprises adding content of a different type than the published content.

13. A wireless communication device including one or more processing circuits configured to:
retrieve published content through a supporting communication network;
modify the published content by adding content; and
republish the modified content through the supporting communication network.

14. The wireless communication device of claim 13, wherein the one or more processing circuits are configured to retrieve published content by downloading audio content from a web feed accessible through the supporting communication network and to modify the published content by adding new audio content to the downloaded audio content.

15. The wireless communication device of claim 14, wherein the one or more processing circuits are configured to republish the modified content by updating a web feed to list the modified content as a republished version of the published content.

16. The wireless communication device of claim 14, wherein the web feed comprises a podcast, and wherein the one or more processing circuits are configured to download an audio file associated with the podcast, and to modify the published content by providing editing functions via a user interface of the wireless communication device and inserting or appending new audio content received via the user interface.

17. The wireless communication device of claim 13, wherein the one or more processing circuits are configured to retrieve published content by retrieving content published in a web feed that is accessible via the supporting communication network.

18. The wireless communication device of claim 13, wherein the one or more processing circuits are configured to modify the published content by adding republication information as at least part of said added content.

19. The wireless communication device of claim 13, wherein the one or more processing circuits are configured to add republication information by adding defined republication tags to aid in later identification and retrieval of the modified content.

20. The wireless communication device of claim 18, wherein the one or more processing circuits are configured to add republication information by at least one of inserting or appending time information to indicate a modification time, inserting or appending wireless communication device location information to indicate a modification location, and inserting or appending defined republication tags to aid in later identification and retrieval of the modified content.

21. The wireless communication device of claim 20, wherein the one or more processing circuits are configured to insert or append location information to the published content that identifies where the wireless communication device was located during modification of the published content.

22. The wireless communication device of claim 13, wherein the one or more processing circuits are configured to generate a user interface indication of new content availability in one or more electronic feeds accessible by the wireless communication device through the supporting communication network.

23. The wireless communication device of claim 22, wherein the one or more processing circuits are configured to generate the user interface indication by at least one of displaying an indicator on a display screen of the wireless communication device, and outputting an audible signal via an audio output circuit of the wireless communication device.
